(19) United States
(12) Patent Application Publication
(10) Pub. No.: US 2004/0036403 A1
(43) Pub. Date: Feb. 26, 2004

(54) Fabrication method of carbon nanotubes

(76) Inventors: Takahito Ono, Sendai-shi (JP); Esashi Masayoshi, Sendai-shi (JP)

Correspondence Address: Norman P Soloway, Hayes Soloway, 130 W Cushing Street, Tucson, AZ, 85701, US

(21) Appl. No.: 10/432,684

(22) PCT Filed: Aug. 31, 2001
(86) PCT No.: PCT/JP01/07587

(30) Foreign Application Priority Data
Dec. 13, 2000 (JP) 2000-379334

(51) Int. Cl. H01J 1/30; H01J 9/04

(52) U.S. Cl. 313/311; 313/495; 445/51; 313/309

(57) ABSTRACT

In this invention, protrusions are formed on a substrate such as silicon and quartz glass, and catalytic metal of transition element, such as nickel, iron and cobalt are coated on the substrate, and carbon nanotubes are grown by hot-filament chemical vapor deposition or microwave-plasma enhanced chemical vapor deposition under an application of negative voltage to the substrate. Where the substrate is heated.

In these methods, carbon nanotubes can be selectively grown from the apex of protrusions. As a substrate, silicon probe for scanning probe microscopy (SPM) can be used. The carbon nanotube probe can be applied to high resolution SPM probe for imaging a precise topographic image.

### TECHNICAL FIELD

This invention involves the fabrication and selective growth of carbon nanotubes (CNTs) for applications of scanning probe microscopy (SPM) probes, field emission display (FED) emitters.

### BACKGROUND ART

Carbon nanotubes (CNTs) are conductive nanostructures and easily emit electrons as a field emitter. Since the discovery of CNTs, many researches have been conducted and various unique properties originated in the inherent nanostructure have been found one after another. Especially the unique structures and the excellent mechanical properties have been attracted attention. The CNTs as can be seen from the name, have the structure as a graphene sheet with one or multi-layer rolls into a tubular. The structure shows high aspect ratio; the diameters are ranging from nm to several-tenth nm, and the length from micrometer to tenfold of micrometer. The high aspect ratio structure enable to concentrate a high electric filed at the end of CNTs, which is very advantageous for a field emitter as vacuum electronic, field emission display, fluorescence display electron microscopy and various analysis based on electron emission. The CNTs are totally consisted of graphene and have excellent mechanical properties, especially a highest mechanical strength owing to the in-plane bonds of graphite.

Various researches to realize novel applications with above unique properties have been proceeding. In some of them, positioning of CNT onto a given point of a device is required.

One of them is a probe for scanning probe microscopy (SPM). The SPM is powerful tool, which enable us to visualize and observe topography on a sample surface in nanometer resolution or weak physical interaction between a sample and a tip. Recently, a carbon nanotube is considered to be ideal material for the probe of SPM. Carbon nanotube tip never change the tip radius with in the diameter and can maintain the high resolution. The carbon nanotube tip can be applicable to observe soft materials, such as biomedical tissues, due to flexible spring. High stress caused by the control error signal at the step of a sample is adsorbed by the soft spring.

However, most of positioning has been done by handling of individual carbon nanotube, which was synthesized in some way, with precisely controlled manipulator and attached on a given position. This technique has problems that it requires a great skill and the production throughput is quite low.

Recently the selective growth onto a SPM probe has been reported, however, it needs a specific technique for a deposition of catalyst.

This invention provides a selective growth technique on a substrate.

### DISCLOSURE OF INVENTION

In order to achieve a selective growth of carbon nanotube in this invention, a carbon nanotube is grown at a protrusion on a metal calalyst-coated substrate by applying a negative voltage to the substrate during chemical vapor deposition.

With this procedure, an individual carbon nanotube can be grown selectively on the protrusion of the substrate easily.

The deposition technique uses hot-filament, named as hot-filament chemical vapor deposition, and also a substrate can be heated by radiation from the hot-filament.

Insulator and semiconductor substrate can be used as a substrate, the protrusion is made of silicon or covered by a thin silicon film. The additional metal catalyst is coated on the silicon protrusion.

This invention involves a field emitter tip with a carbon nanotube that is formed by above method at the top of the protrusion. This field emission tip structure can be utilized for SPM and topographic image of a sample can be precisely undertaken with a high resolution.

This invention also involves the field emitters and wiring of metal for addressing a working emitter.

### BREIF DESCRIPTION OF THE DRAWINGS

FIG. 1 shows the schematic figure of the growth model of a carbon nanotube.

FIG. 2 shows the schematic figure of the hot filament chemical vapor deposition (HF-CVD) for the selective growth of an individual carbon nanotube.

FIG. 3 shows the fabrication step of a carbon nanotube tip on a scanning probe microscopy probe.

FIG. 4 shows the schematic figure of selective growth of a carbon nanotube on a tip under an application of electric field.

FIG. 5 shows the scanning electron microscopy (SEM) images of the fabricated carbon nanotube tip.

FIG. 6 shows the SEM image of a tip on which carbon nanotubes were entirely grown.

FIG. 7 shows the comparison of topographic images undertaken by (a) a carbon nanotube tip and (b) a commercial scanning probe tip by SPM.

FIG. 8 shows the schematic fabrication process of a carbon nanotube electron emitter by the selective growth technique.

FIG. 9 shows the cross sectional view of the carbon nanotube electron emitter.

### BEST MODES FOR CAREYING OUT THE INVENTION

The detail of this invention is described below using figures.

Inventors had observed the growth features of carbon nanotubes on dots of catalytic metal, and it was found that an application of electric field changes their features. Using relatively simple method, the selective growth technique of a carbon nanotube on a protrusion had been developed.

<Electric Field Induced Selective Growth of Carbon Nanotube>

Growth of carbon nanotubes requires catalytic metals, such as Ni, Co, and Fe. Prior to the carbon nanotube growth, by patterning of the catalytic metal using lithography based on a semiconductor planer technique, carbon nanotubes can be selectively grown on it.

However, very small dot pattern and accuracy are needed to be grown an individual carbon nanotube on a given position with this method, such as electron beam lithography, and the throughput decreases as decreasing the pattern size.

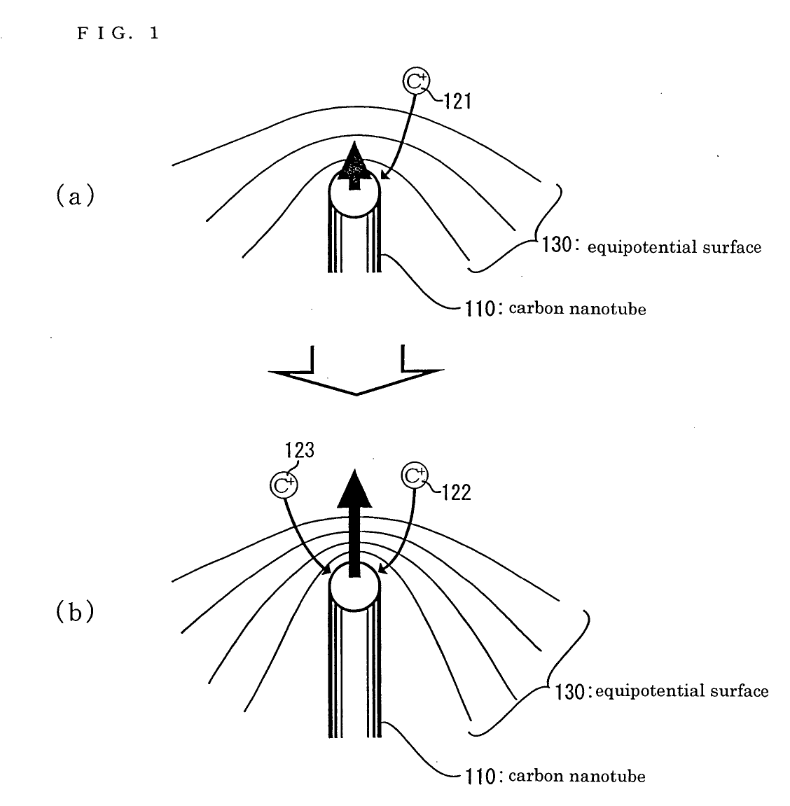

In order to develop more effective way to grow a carbon nanotube selectively, inventers pay attention to a pseude-liquid growth model of carbon nanotubes proposed by Saito et al. (Y. Saito, T. Yoshikawa, M. Inagaki, M. Tomita and T. Hayashi: Chem. Phys. Lett. 204, 277(1993)). FIG. 1 shows the schematic of the growth model. Carbon ion species 121˜123 are deposited on a carbon nanotube 110 in an equipotential surface in FIG. 1. Catalytic metal become a liquid state at the end of carbon nanotube during growth in FIG. 1(a). The carbon nanotube 110 is pull out and extend to the direction of electric field due to the electrostatic force as shown in FIG. 1(b). The high electric field results in the deposition of polarized neutral or ion carbon species 121˜123. This mechanism plays an important role in the selective growth of the carbon nanotube.

As described later, it is expected that the protrusion on a substrate and an application of voltage will concentrate electric field and enhance the growth rate of a carbon nanotube at the apex of the protrusion for the selective growth.

<Hot-filament Chemical Vapor Deposition>

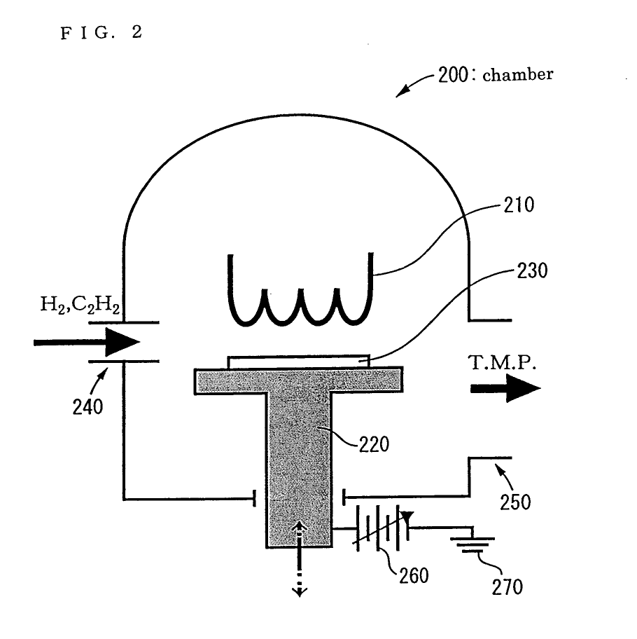

FIG. 2 shows the schematic figure of the hot-filament chemical vapor deposition (HF-CVD) for the selective growth of carbon nanotubes. Up to now an arc-discharge method and laser ablation method have been widely employed, however, these methods have never been applied to selective growth on a substrate. Physical enhanced chemical vapor deposition can apply to selective growth; however, the selectivity of carbon nanotube growth seems to be not sufficient for growing an individual carbon nanotube. We investigated the selective growth of carbon nanotubes using the HF-CVD as shown in FIG. 2.

In FIG. 2, a growth chamber 200 is equipped with a gas line for flowing gases 240, an exhaust opening 250, a hot-filament 210 and a movable stage to z direction 220. A substrate 230 is mounted on the stage 220, which is connected to a variable DC source 260. Source gases are introduced into the chamber 200 via the gas line 240, and decomposed and activated by the heated filament 210. These activated specimens near the filament 210 are supplied to the substrate 230. The substrate 230 is heated by the radiation from the filament. To prior the growth, a metal thin film (nickel) is coated on the substrate. The catalytic metal reacts with activated species and carbon nanotubes are grown from them.

### EXAMPLES

<Probe for Scanning Probe Microscopy>

In following example for fabricating a probe tip, if there is no description, the HF-GVD was performed by following condition. Acetylene (C₂H₂) gas diluted by hydrogen (H₂) was employed as a source gas. The partial pressure of acetylene and hydrogen are 3, 27 Pa, respectively. Tungsten wire with a diameter of 0.6 mm was used as the hot-filament.

During the growth, the tungsten filament 210 was heated at 1900° C. by flowing a current and the temperature was measured by a pyrometer from the outside of the chamber 200. The distance between the filament 210 and the substrate 230 was adjusted to be about 5 mm with a Z-linear motion mechanism. As a sample specimen, a commercial SPM probe made of silicon was used. Prior to the CVD growth, several-nm thick nickel was deposited entirely on the sample. The CVD process was done for 15 min.

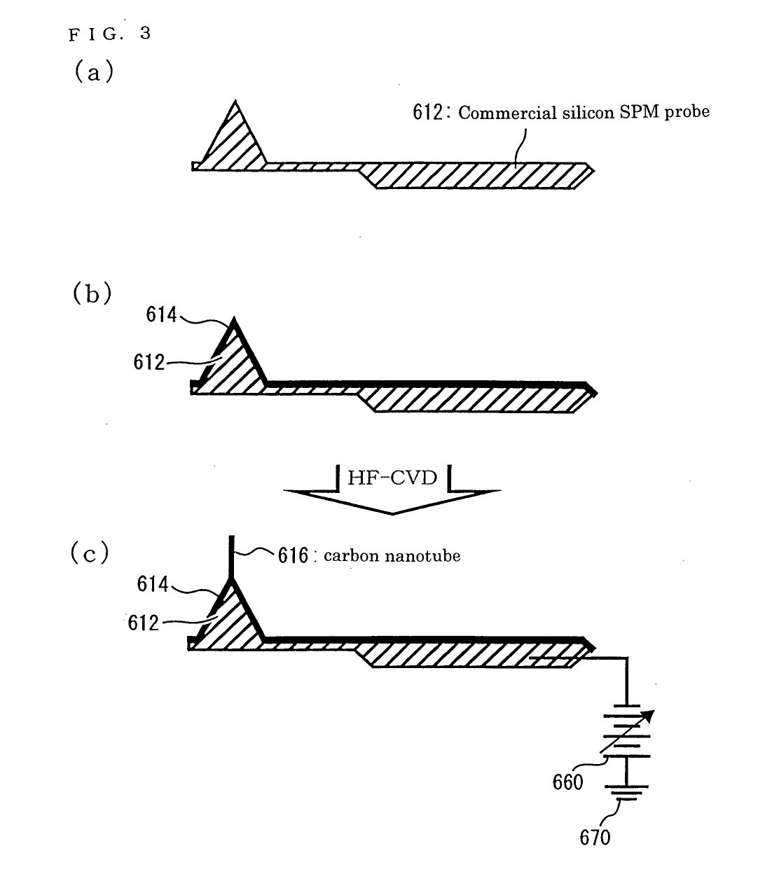

FIG. 3 shows the process flow of an individual carbon nanotube using the commercial probe (FIG. 3(a)). A 5-nm-thick nickel film 614 was coated entirely on the tip side of the SPM probe 612 by sputtering (FIG. 3(b)). An individual carbon nanotube 616 was grown from the apex of the SPM probe by an application of voltage to the sample specimen during the growth (FIG. 3(c)). Using the variable DC source, a voltage can apply to the substrate during the growth. Experimental results on the SPM probe at voltage of 300 V, 0 V and −300 V are summarized in Table 1.

| Stage voltage | 300 V | 0 V | −300 V |
|---|---|---|---|
| Status of Carbon | Not grown | Entirely grown | Selectively grown |
| nano nanotube | | | at the tip apex |

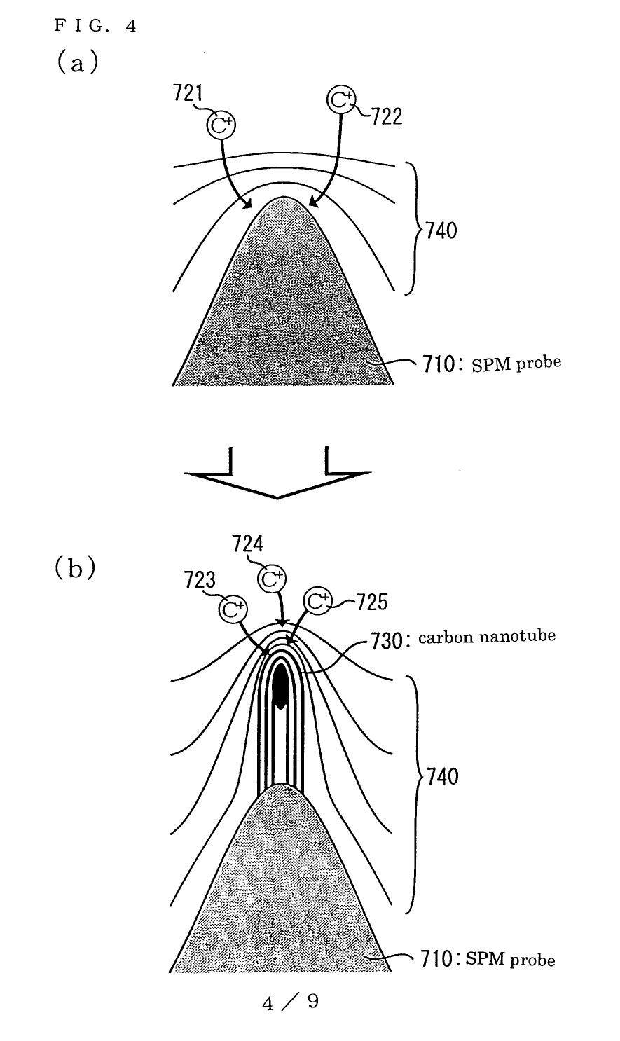

As shown in Table 1, the application of negative voltage enhances the growth of a carbon nanotube at the apex of the SPM tip. FIG. 4 shows the schematic figure of the selective growth of the carbon nanotube in the electric field. During the growth, carbon ion and polarized neutral species exist in the chamber.

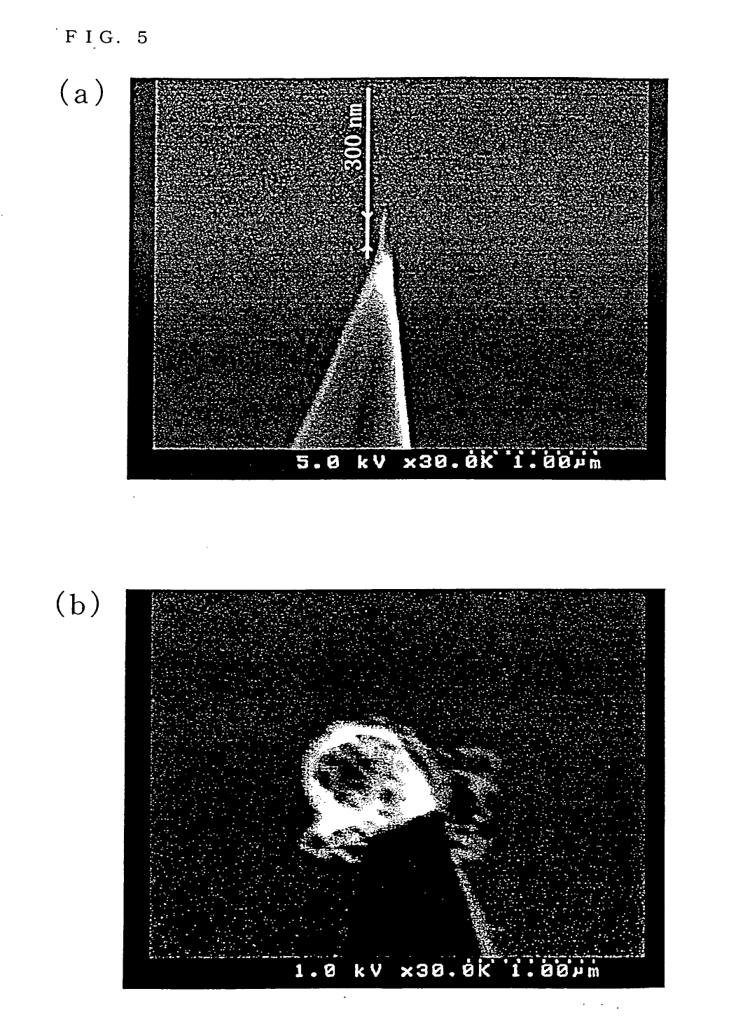

In FIG. 4(a), the electric field concentrates at the apex of the probe 710 as the equipotential surface is shown in figure. Electrostatic attracting force acts on the species and these species are deposits on the apex of the probe 710. As shown in FIG. 4(b), the electrostatic force pulls out a catalytic metal particle to electric field and extends the surface, which also induces the carbon nanotube 730 growth together with the effect of electric field induced deposition of carbon species. FIG. 5(a) shows the typical scanning electron microscopy (SEM) image of a 300-nm-long carbon nanotube, which was grown on a nickel coated commercial silicon probe 710.

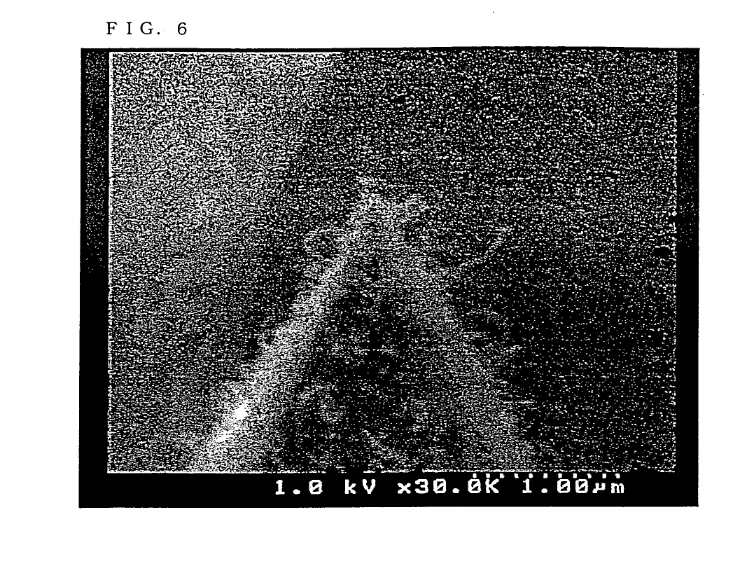

Furthermore, when the apex of a tip was trapezoidal and not enough sharp, a number of carbon nanotubes were grown from the end of the tip, as shown in FIG. 5(b). This is because that the high electric field is generated at the wide area of the tip due to the tip geometry, not exactly at the apex of the tip. In this case, electric field was concentrated at the edge of the trapezoidal tip end, and the many carbon nanotubes were grown from the edge. When no voltage was applied to the tip, carbon nanotubes were entirely grown from the tip end, as shown in FIG. 6. In this case, slight built-in voltage is generated by irradiation of thermal electron from the hot filament; however, this built-in voltage was not enough to grow an individual carbon nanotube, and many carbon nanotubes were grown.

Topographic imaging using an SPM probe fabricated in this way was conducted in order to demonstrate the quality of the tip so produced. The probe used had a fundamental resonant frequency of about 145 kHz, and the CNT was approximately 50 nm in diameter and 400 nm in length. A SiC chip was observed in tapping mode. Dot patterns with a periodicity of 75 nm and a dot diameter of about 50 nm were formed on the SiC chip using electron beam lithography followed by dry etching.

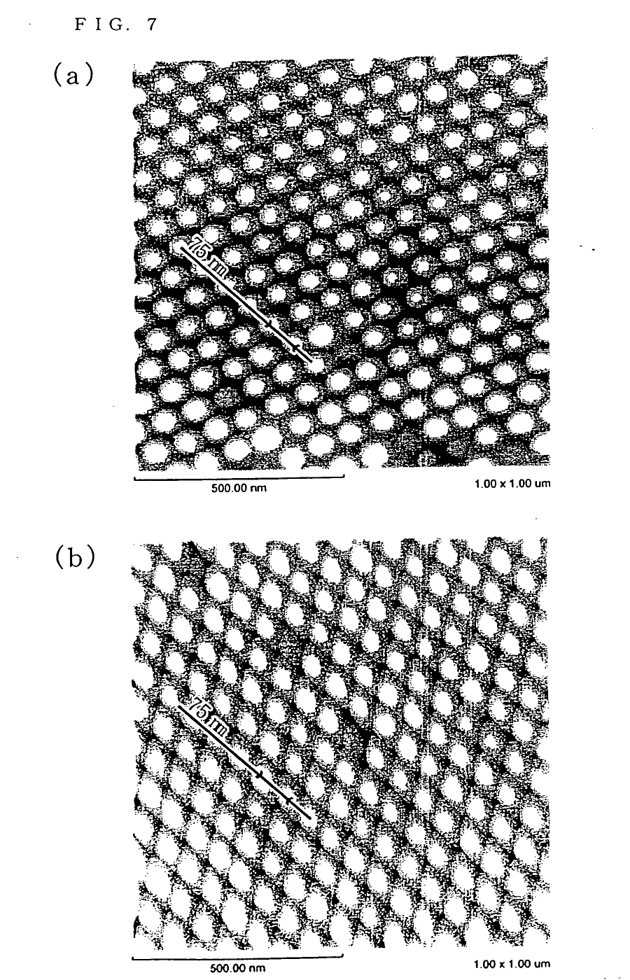

The images obtained using the CNT SPM tip with those obtained using an unmodified commercial tip are shown in FIGS. 7(a) and (b), respectively; a clear difference in quality can be seen. The high-aspect-ratio nanotube can get in fine structures and trace them. The rhomboidal shape of the dots in FIG. 7(b) shows a tip artifact depending on the tip geometry. The high-aspect-ratio nanotube provides an image that is close to reality.

<Electron Emitter for Field Emission Display>

Example of an application of the carbon nanotubes as electron emitter (cold cathode) for field emission display is described below.

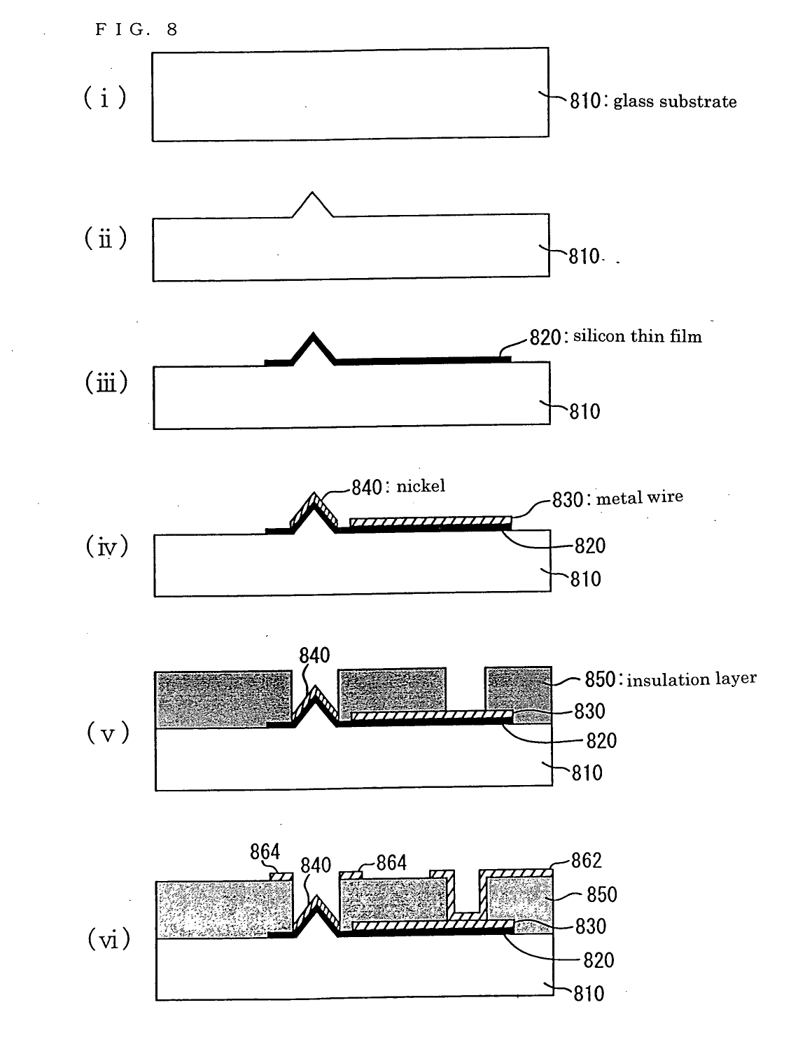

FIG. 8 shows the fabrication sequence of the electron emitter, and the detail is described below in sequence of (i)˜(vi).

A glass substrate 810 was prepared (FIG. 8(i)), and a protrusion (tip) was formed by etching (FIG. 8(ii)). A silicon thin film was deposited for making an electrode on the tip (FIG. 8(iii)). Then metals were deposited for making metal wires 830 and catalytic seed layer (Nickel) 840 for carbon nanotube growth (FIG. 8(iv)). Next an insulation layer 850 was deposited entirely on the substrate 810, and feed through holes were formed by etching (FIG. 8(v)). For electrical contact to metal wires 830, metal wires 862 were formed in the feed through, and metal wires 864 were formed around tips (FIG. 8(vi)). Finally, carbon nanotubes were grown by the HF-CVD.

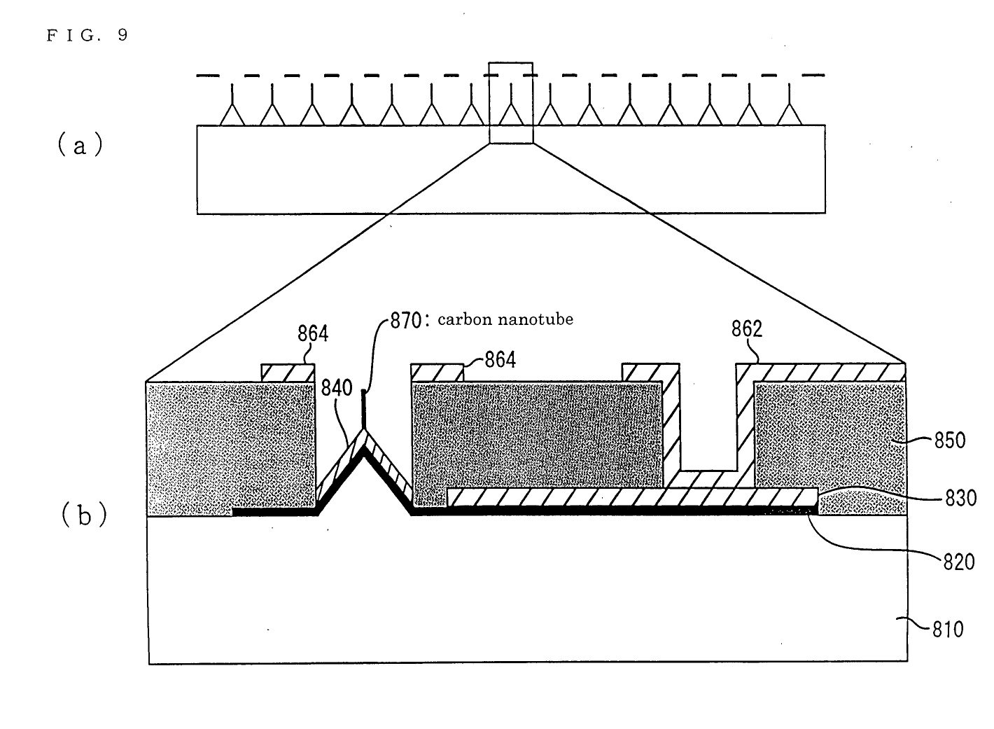

FIG. 9 shows the cross sectional view of the aligned field emitter grid for the field emission display, as fabricated by above fabrication process. FIG. 9(a) shows the field emitter grid, and FIG. 9(b) shows the magnified sketch of the cross section, on which an individual carbon nanotube 870 was formed.

The ability of field emission using the carbon nanotube is excellent in the low threshold and long durability for electron emission.

### Other Examples

In previous examples, acetylene gas (C₂H₂) diluted by hydrogen gas (H₂) was used as a source gas, other source gases, such as ethylene (C₂H₄) and methane (CH₄) are also applicable for the carbon nanotube growth. We confirmed that carbon nanotubes were grown by using the methane gas diluted by hydrogen. However, the relatively straight and high density carbon nanotubes were produced in use of acetylene as a source gas.

In our experiments, HF-CVD was used for the selectively growth. However, a plasma-enhanced chemical vapor deposition technique can be applied to the selective growth. In these technique, temperature of the substrate must be controlled by a heater.

In addition, the diameter of carbon nanotube can be controlled by the heating temperature and the thickness of the catalytic metal film.

Code in Figures

110 carbon nanotube

121-123 carbon ion

130 equipotential surface

200 chamber

210 hot filament

220 stage

230 substrate

240 gas inlet

250 gas exhaust

260 power source

270 earth

612 Commercial silicon SPM probe

614 nickel

616 carbon nanotube

660 power source

670 earth

710 SPM probe

721-725 carbon ion

730 carbon nanotube

740 equipotential surface

810 glass substrate

820 silicon thin film

830 metal wire

840 nickel

850 insulation layer

862, 864 metal wires

870 carbon nanotube

1. A method for forming a carbon nanotube comprising:
generating a thin film of a catalyst metal on a substrate having a projection;
laying a stage mounted with the substrate into a negative voltage by use of vapor phase deposition method; and
growing the carbon nanotube on the projection while heating the substrate.

2. The method for forming a carbon nanotube according to claim 1 wherein the vapor phase deposition method is a hot-filament chemical vapor phase deposition method, and the heating of the substrate is carried out by use of the radiation of a hot filament.

3. The method for forming a carbon nanotube according to claim 1 or 2 wherein the substrate is a substrate of an insulating material, the substrate comprises a silicone film formed on the projection, and the thin film of the catalyst metal is formed on the silicon film.

4. An electron emission source structure having, on a projection, a carbon nanotube formed by use of the method for forming a carbon nanotube according to any one of claims 1-3.

5. A field emission display comprising an electron emission source structure having, on a projection, a carbon nanotube formed by use of the method for forming a carbon nanotube according to claim 3, and a wiring for selecting the electron emission source.
